(19) United States
(12) Patent Application Publication
(10) Pub. No.: US 2012/0248252 A1
(43) Pub. Date: Oct. 4, 2012

(54) COOLING SYSTEM FOR FUEL CELL SYSTEMS, METHOD FOR COOLING FUEL CELL SYSTEMS, AND A FUEL CELL SYSTEM

(75) Inventors: Baker AL-ALI, Hamburg (DE); Moeed Ejaz KHAWAJA, Barsbuettel (DE)

(73) Assignee: AIRBUS OPERATIONS GMBH, Hamburg (DE)

(21) Appl. No.: 13/441,286

(22) Filed: Apr. 6, 2012

Related U.S. Application Data
(63) Continuation of application No. PCT/EP2010/052511, filed on Feb. 26, 2010.
(60) Provisional application No. 61/249,114, filed on Oct. 6, 2009.
(60) Provisional application No. 61/249,116, filed on Oct. 6, 2009.

(30) Foreign Application Priority Data
Oct. 6, 2009 (DE) 10 2009 048 393.4
Oct. 6, 2009 (DE) 10 2009 048 394.2

(51) Int. Cl. H01M 8/04; B64D 37/34

(52) U.S. Cl. 244/135 R; 429/437; 429/435

(57) ABSTRACT

A cooling system for cooling a fuel cell system in a vehicle is used for thermal connection with fuel in a fuel tank. This results in the use of the fuel in a fuel tank as a heat sink with a high thermal capacity and an essentially constant cooling capacity due to the relatively stable temperature of the fuel. Cooling of the fuel cell system can thus be implemented with very simple means and in a particularly lightweight manner.

### CROSS-REFERENCE TO RELATED APPLICATIONS

This is a continuation of International Application No. PCT/EP2010/052511, filed Apr. 4, 2011, which claims priority to German Applications No. 10 2009 048 394.2 and No. 10 2009 048 393.4, filed Oct. 6, 2009, and also claims priority to U.S. Provisional Applications No. 61/249,114 and No. 61/249,116, filed on Oct. 6, 2009, the contents of which are hereby incorporated by reference in their entirety.

### TECHNICAL FIELD

The technical field relates to a cooling system for fuel cell systems, to a method for cooling fuel cell systems, to the use of a cooling system, and to an aircraft with at least one fuel cell system and with a cooling system for cooling the fuel cell system.

### BACKGROUND

The use of fuel cell systems in vehicles, in particular in aircraft, suggests itself by very low noise emission and pollutant emission in various operational phases of the vehicle. Apart from the provision of electrical power, depending on their size and design, fuel cell systems also produce corresponding exhaust heat that needs to be removed. To this effect in prior art, among other things heat transfer devices through which water flows are used, which heat transfer devices are thermally connected to the fuel cell system. Due to in some cases quite considerable heat development during such cooling, high-performance fuel cell systems that comprise one or several so-called stacks require considerable quantities of cooling air in order to keep the operating temperature of the fuel cell system at an optimal level.

Furthermore, DE 10 2006 046 114 A1 shows a cooling arrangement for cooling a fuel cell for an aircraft, which cooling arrangement comprises a Peltier element that with its cold side is in contact with the fuel cell. Moreover, DE 10 2007 060 428 B3 and WO 2009 077 048 A1 show an evaporation cooling system that is in thermal contact with a fuel cell in order to absorb heat generated by the fuel cell during operation of said fuel cell by evaporation of a cooling medium and in order to remove said heat from the fuel cell.

In particular in the integration in an aircraft, cooling a fuel cell system provides a considerable challenge. This is particularly the case in low-temperature fuel cells, in which the temperature level, as a rule, is significantly below 100° C. Thus, on hot days a correspondingly low temperature gradient between the fuel cell system and the ambient air results, and consequently heat transfer to the environment is made difficult.

In particular in the use of fuel cell systems in aircraft and the associated cooling requirements, it may be considered to be disadvantageous to provide adequate quantities of cooling air, or to generate on board the aircraft the electrical power required for cooling or conveying a large quantity of cooling air, because in particular on board aircraft there is an endeavor to minimize power or energy requirements in order to reduce fuel consumption.

It may thus be at least one object to propose a cooling system for cooling fuel cell systems, in which cooling system not only adequate cooling of a fuel cell system can be attained, but also at the same time the requirement for cooling air and the energy requirement for cooling can be minimized. At least a further object is to propose such a cooling system, which comprises as compact a design as possible and allows reliable operation with as little maintenance as possible. In addition, at least another object is to propose a fuel cell system that has as compact a design as possible and that can be cooled efficiently. Moreover, other desirable features and characteristics will become apparent from the subsequent summary and detailed description, and the appended claims, taken in conjunction with the accompanying drawings and this background.

### SUMMARY

According to a first embodiment, at least one cooling circuit with a first heat transfer device is proposed that thermally communicates both with the fuel cell system and with a fuel tank in such a manner that the first heat transfer device can give off heat of the fuel cell system to fuel in the fuel tank. This has the technical effect in that improved cooling of the fuel cell system can be achieved with the heat sink implemented in the form of fuel, for example kerosene. This is due to the thermal capacity, which is significantly higher than that of air, of the fuel, and to the fact that in larger vehicles, which may comprise larger fuel cell systems with very considerable heat dissipation, usually a correspondingly large quantity of fuel is kept. Using the fuel as a heat sink is, for example in the case of aircraft situated on the ground, very advantageous because the temperature of the fuel is often lower than that of the ambient air. The temperature differential to the fuel cell system or to the heat transfer device thermally connected with said fuel cell system can correspondingly be larger than in the case of conventional air-cooled systems so that improved heat transfer is possible.

Because of these advantages a reduction in the size of heat transfer devices connected to the fuel cell system can be achieved, which provides significant advantages relating to the required design space and weight. At the same time, as a result of the relatively large fuel mass in larger vehicles or aircraft, it can be assumed that the temperature of the fuel is not subjected to excessive fluctuations, and, consequently, permanently reliable and adequate cooling can be assumed, which can be carried out by means of a lightweight and low-maintenance cooling system.

It should be pointed out that in this document the term “first heat transfer device” refers to a device that is able to give off heat of the fuel cell system to a cooling medium of any design. The first heat transfer device may be integrated directly in the fuel cell system and/or in the fuel cells of the fuel cell system, be it by means of a separate physical unit, by flow channels in a fuel cell housing, through which flow channels cooling medium flows, or the like. The first heat transfer device need not necessarily transfer heat between two substance streams, for example between hot exhaust gas and the cooling medium; instead, it is also imaginable for the first heat transfer device to be designed in the manner of a cooling element. The cooling element may comprise flow channels for conducting the cooling medium through it or past it. Finally, the embodiments are not limited to the design of the first heat transfer device; instead, it is merely pointed out that a device is present that can remove heat, which arises in a fuel cell system, with a cooling medium (hereinafter also referred to as a “fluid”).

According to an embodiment of the cooling system, the first heat transfer device is connected, by way of a contact surface, to at least one heat-dissipating contact surface of the fuel cell system and comprises flow channels for a first fluid that removes the heat of the fuel cell system, which heat is absorbed by the first heat transfer device. The first fluid can be implemented by the fuel itself, which is conveyed from the fuel tank by way of a corresponding feeder line through the flow channels of the first heat transfer device, in order to absorb heat in that location.

In a further embodiment of the cooling system, an alternative substance, for example water, oil, ethanol or the like, is used as a first fluid. This first fluid flows through flow channels or the like of the first heat transfer device and through a heat dissipation device that is designed, by way of a second cooling circuit, to give off heat to the fuel in the fuel tank. This approach helps avoid having to install in the aircraft extensive feeder lines through which fuel flows, which feeder lines are potentially hazardous, exclusively in order to cool the fuel cell system.

In another embodiment of the cooling system the heat dissipation device is designed as a second heat transfer device that is arranged outside the fuel tank. Heat is given off to the fuel. The second heat transfer device comprises separate flow channels through which the first and a second fluid flow. The second fluid is implemented in the form of fuel from the fuel tank, which fuel by way of corresponding fuel lines is taken from the fuel tank and having absorbed heat is returned. Consequently, only one fuel outlet and one fuel inlet needs to be implemented on the fuel tank, which fuel inlet and fuel outlet can communicate with a second heat transfer device, which is arranged externally. In this arrangement the term “fuel inlet” refers to an opening and/or a valve that allows a fuel flow into the fuel tank. In contrast to this, the term “fuel outlet” describes an aperture and/or a valve and/or some other suitable device that allows controlled fuel flow from the fuel tank.

Furthermore, another embodiment arranges the second heat transfer device in a region in close proximity to a fuel tank so that the largest distance between the fuel cell system and the fuel tank, namely between the first heat transfer device and the second heat transfer device, can be bridged with a clearly less hazardous cooling medium.

Preferably, the fuel inlet and the fuel outlet are arranged at clearly spaced-apart positions of the fuel tank so that the situation does not arise in which, due to continuous removal of a small part of the fuel, excessive heating of this part occurs. For example, the fuel inlet and the fuel outlet are spaced apart from each other by approximately 50 cm or more so that good mixing with the remaining fuel can take place between the fuel inlet and the fuel outlet. Furthermore, it is preferred if the fuel inlet is designed to convey fuel that flows back into the tank so that it flows in the direction pointing away from the fuel outlet. In this manner, too, it is possible to avoid re-heating an already heated part of the fuel. As an alternative to the aforesaid, the second heat transfer device can also be placed directly in a fuel tank so that the additional lines from and to the second heat transfer device are obsolete.

In a further embodiment of the cooling system the cooling system is connected to two or more fuel tanks. This means that fuel from more than only one fuel tank flows through or around, or can surround, the first heat transfer device or the second heat transfer device, and consequently improved heat transfer to fuel can be achieved because a larger quantity of fuel is available to absorb heat. Likewise, in another embodiment the cooling system can comprise a valve arrangement with several valves and with a control unit that is connected to the valves, which control unit is designed to connect the cooling system as desired, one after the other, at the same time, or in an alternating manner, to one or several fuel tanks. Thus by acquiring the temperatures of the fuel with one or several temperature sensors located in the fuel tanks, which temperature sensors are connected to the control unit, it may be ensured that the cooling system regularly impinges that fuel tank in the vehicle with heat, which fuel tank comprises the lowest temperature. For this reason the control unit may comprise corresponding programming. This may be advantageous in particular in the case of larger fuel cell systems, because excessive heat transfer to individual fuel quantities can practically be excluded as a result of this, and, with alternating impingement (taking turns) or successive impingement of fuel from several fuel tanks, improved heat transfer of the heated fuel from a fuel tank to the surroundings can take place when a change to another fuel tank has taken place. A second heat transfer device may thus be impinged with fuel from different fuel tanks, while also several second heat exchangers may be accommodated in different fuel tanks and when needed connected as required to the first heat transfer device by way of the valve arrangement.

According to a further embodiment, a fuel cell system is proposed which in conventional operation generates heat that can be dissipated by way of a cooling system with any desired number of the above-mentioned characteristics.

A feature of one embodiment of the fuel cell system in that apart from fluid-based cooling the fuel cell system, too, may be accommodated in a fuel-proof housing that may be integrated directly within a fuel tank of the vehicle, so that heat may be transferred to said fuel tank by way of direct contact with the fuel.

In an embodiment of such a fuel cell system, a heat dissipation device is arranged on the housing, which heat dissipation device is, for example, implemented with heat dissipation surfaces that can comprise a profiled surface that allows particularly good heat transfer to a surrounding fluid. There is no need to affix separate heat dissipation devices to the housing; it is also possible to design the housing in such a manner that improved heat dissipation is possible. In the simplest case such a heat dissipation surface may be implemented in the form of cooling fins that are affixed to the outside of the housing. Nonetheless, the invention is not solely limited to the use of cooling fins or profiled surfaces generally; instead, the heat dissipation device may also be implemented in the form of an electrical or pneumatic device.

According to an embodiment of such a fuel cell system, the heat dissipation device is connected by way of at least one contact surface with the heat-dissipating contact surface of at least one fuel cell, and comprises heat transfer surfaces, for example cooling fins or the like, which are in contact with the fuel in the fuel tank.

In another embodiment of such a fuel cell system a holding device is provided that is arranged on the fuel cell system, where the fuel cell system is designed to be arranged so as to be spaced apart from walls of the fuel tank. In this manner, heat build-up in regions near the wall or the like can be prevented, and the fuel cell system is exposed on all sides to flowing fuel. Furthermore, this means that the heat dissipation device may be distributed over all the outside surfaces of the fuel cell system. The housing of the fuel cell system may thus form the heat dissipation device.

According to an embodiment of such a fuel cell system, furthermore, at least one supply line is arranged on the fuel cell system, which supply line is designed, starting from the fuel cell system, to be led from the fuel tank. In this document the expression of “the at least one supply line” can be interpreted as referring not only to a single line, but also to a bundle of individual pipes, tubes hoses or the like, which in an advantageous manner may also be enclosed by a shared channel or a sheath. The at least one supply line is required for feeding operating materials and control signals, and for removing reaction products and sensor signals or the like for operating the fuel cell; the supply line makes it possible to deliver electrical power to corresponding consumers in the aircraft.

An embodiment of such a fuel cell system comprises a reformer that is designed to be supplied directly with fuel from the fuel tank. Consequently, it may be possible to do without lines for supplying fuel to the fuel tank; only an inlet aperture, a nonreturn valve and other safety devices are necessary, so that significant weight savings can occur. Reaction products and electricity are conveyed to the outside by way of corresponding supply lines; the fuel cell system may be controlled by signals from the outside.

Likewise, the fuel cell system comprises an emergency shutdown device that is designed to stop operation of the fuel cell system as soon as the fuel level drops to, or below, a predetermined minimum fuel level in the fuel tank, which minimum fuel level is to be maintained. In this manner any overheating of the fuel cell system can be prevented.

### BRIEF DESCRIPTION OF THE DRAWINGS

Further characteristics, advantages and application options are disclosed in the following description of the exemplary embodiments and of the figures. All the described and/or illustrated characteristics per se and in any combination form the subject of the embodiments, even irrespective of their composition in the individual claims or their interrelationships. Furthermore, identical or similar components in the figures have the same reference characters, where:

FIG. 1 shows a diagrammatic view of the cooling system;

FIG. 2a and FIG. 2b show two similar exemplary embodiments of the cooling system;

FIG. 3 shows a further exemplary embodiment of the cooling system;

FIG. 4a and FIG. 4b show similar exemplary embodiments of the cooling system with several fuel tanks;

FIG. 5a to FIG. 5d show various exemplary embodiments of a fuel cell integrated in a fuel tank;

FIG. 6a and FIG. 6b show a diagrammatic block view of methods; and

FIG. 7 shows an aircraft with at least one fuel tank and at least one cooling system.

### DETAILED DESCRIPTION

The following detailed description is merely exemplary in nature and is not intended to limit application and uses. Furthermore, there is no intention to be bound by any theory presented in the preceding background or summary or the following detailed description.

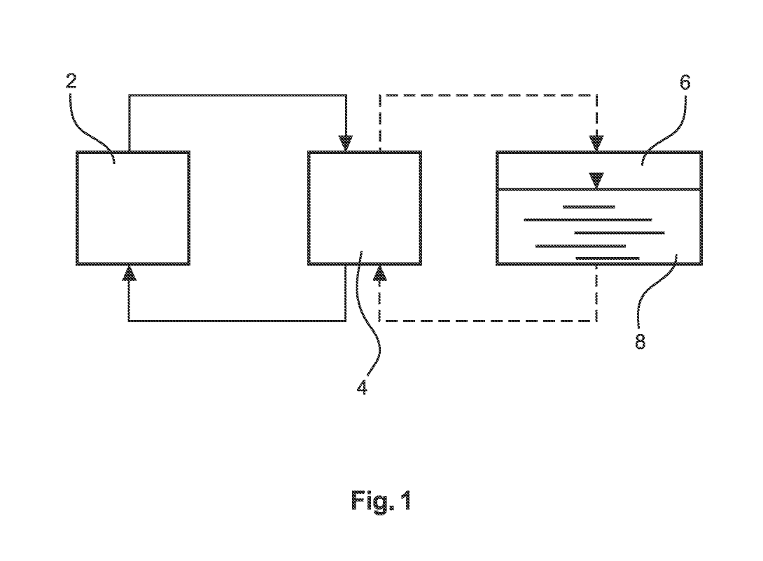

FIG. 1 diagrammatically shows a fuel cell system 2, a cooling system 4 according to an embodiment and a fuel tank 6. The cooling system thermally communicates both with the fuel cell system 2 and with the fuel tank 6. The fuel cell system 2 need not necessarily accommodate only a single fuel cell; instead, a multitude of fuel cells, so-called fuel cell stacks, are imaginable. Furthermore, the fuel tank 6 need not exclusively be a single fuel tank 6; instead, several fuel tanks are also imaginable. The cooling system 4 is designed to absorb heat from the fuel cell system 2 and to transfer the heat to the fuel 8 in the fuel tank 6. Thermal communication between the cooling system 4 and the fuel cell system 2 can take place in several different ways including with direct heat transfer through housing boundary surfaces, or by means of a cooling circuit.

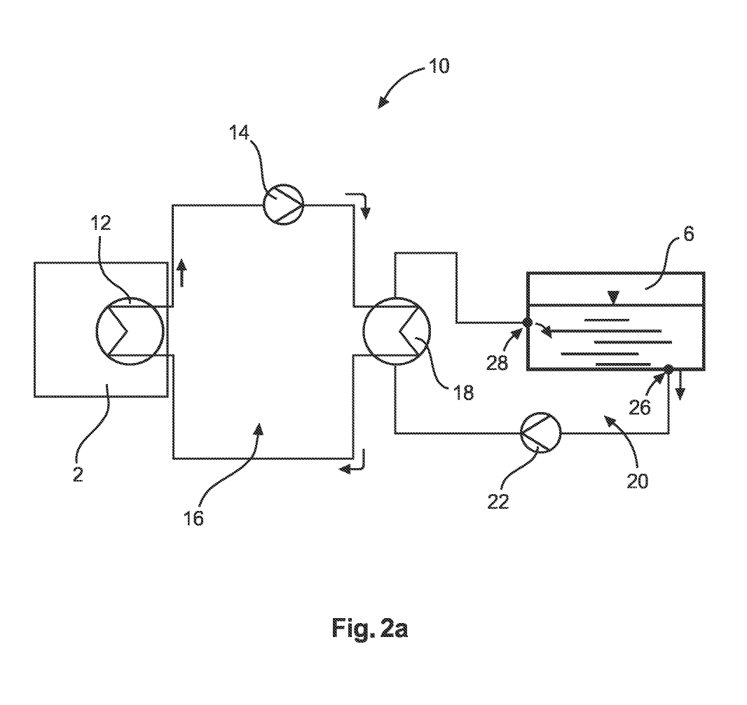

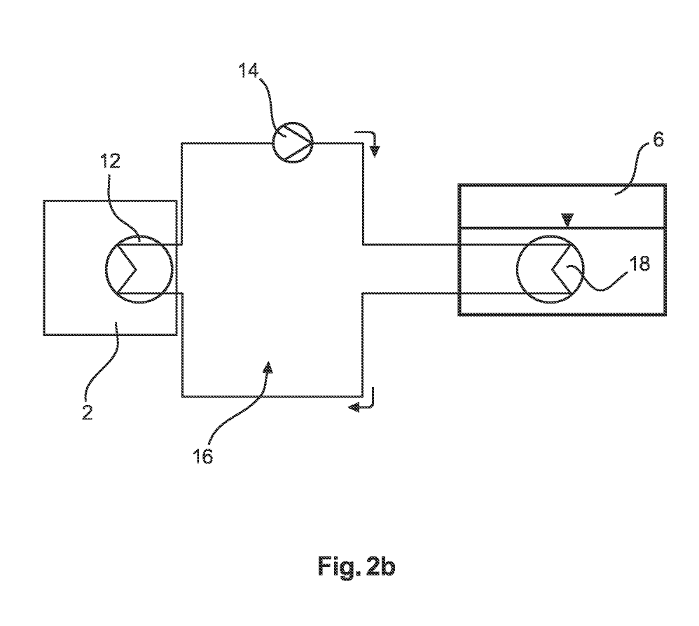

FIG. 2a shows a first exemplary embodiment of a cooling system 10, in which a first heat transfer device 12 is arranged on the fuel cell system 2 in order to in that location absorb the heat generated. The first heat transfer device 12 can either be situated inside the fuel cell system 12 or outside the fuel cell system 2. The first heat transfer device can also be designed in the form of flow channels in parts of a housing of the fuel cell system 2.

A first cooling medium flows through the first heat transfer device 12. The first cooling medium is transported, with a conveying device 14, to a first cooling circuit 16. In this embodiment, the cooling medium can be of any type; when used in an aircraft, for example ethanol would make sense, but water comprising a corresponding antifreeze agent would also be imaginable, as would oil or the like. Furthermore, the first cooling circuit 16 is connected to a second heat transfer device 18 that is designed to transfer the heat to a second cooling circuit 20. This second cooling circuit 20 can communicate with the fuel tank 6, and consequently fuel can be used as the cooling medium in the second cooling circuit 20. This fuel removes the heat from the second heat transfer device 18 and introduces it into the fuel mass in the fuel tank 6. A second conveying device 22 conveys the fuel in the second cooling circuit.

By means of the design comprising two separate cooling circuits 16 and 20, a situation can be achieved in which the fuel-carrying lines can be limited in length, while the largest distance from the fuel cell system 2 to the fuel tank 6 can be covered by a cooling medium that is less hazardous. To this effect, in a particularly advantageous manner, the second heat transfer device 18 can be in the vicinity of the fuel tank 6. FIG. 2b shows a modification of the system shown in FIG. 2a, in which the second heat exchanger 18 is arranged directly within the fuel tank 6, and consequently no separate cooling circuit 20 is required.

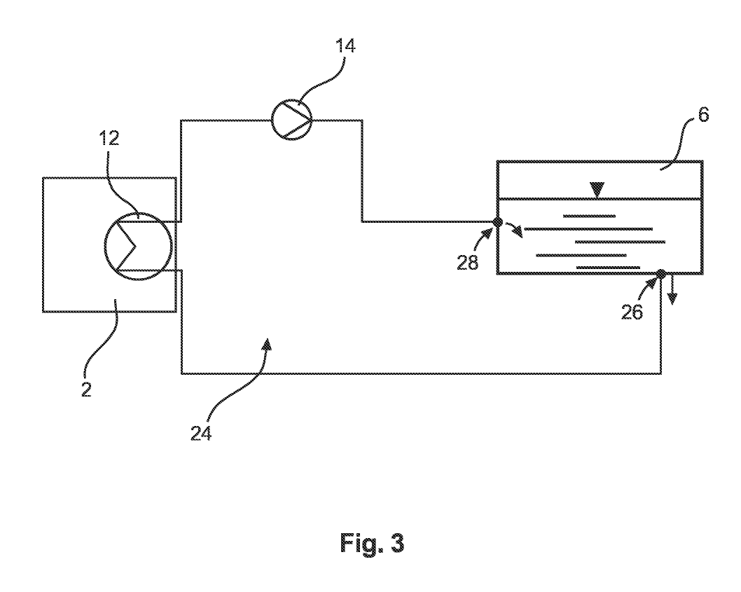

A further modification is shown in FIG. 3, in which modification only a first cooling circuit 24 is present, which is connected to the first heat transfer device 12, to a conveying device 14, as well as to a fuel outlet 26 and a fuel inlet 28 of the fuel tank 6. This relatively simple variant only uses conveyed fuel from the fuel tank 6 in order to flow directly through the first heat transfer device 12 and in this way absorb heat from the fuel cell system 2. This variant makes sense in particular when the distance between the fuel cell system 2 and the fuel tank 6 is not particularly long, and consequently no particularly long distances need to be bridged with lines that carry fuel.

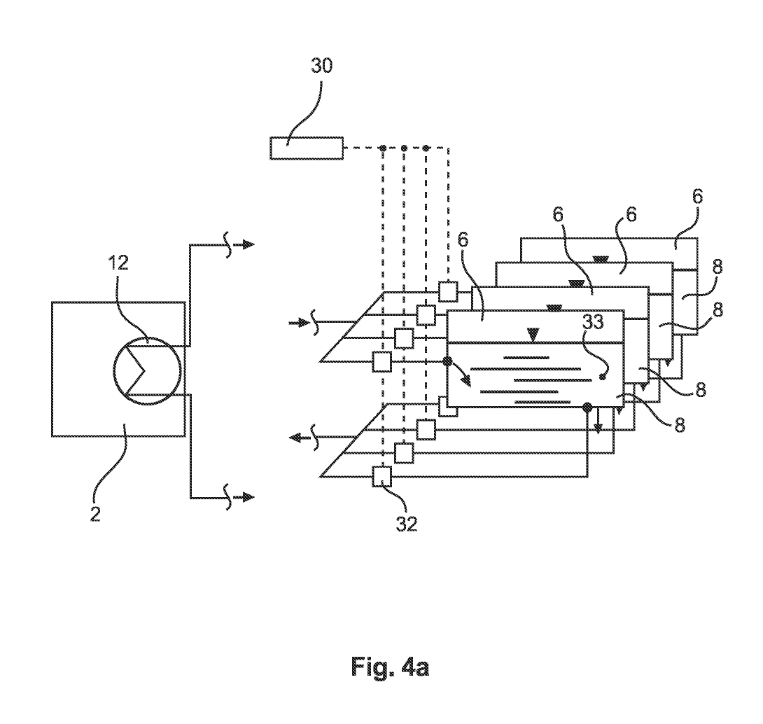

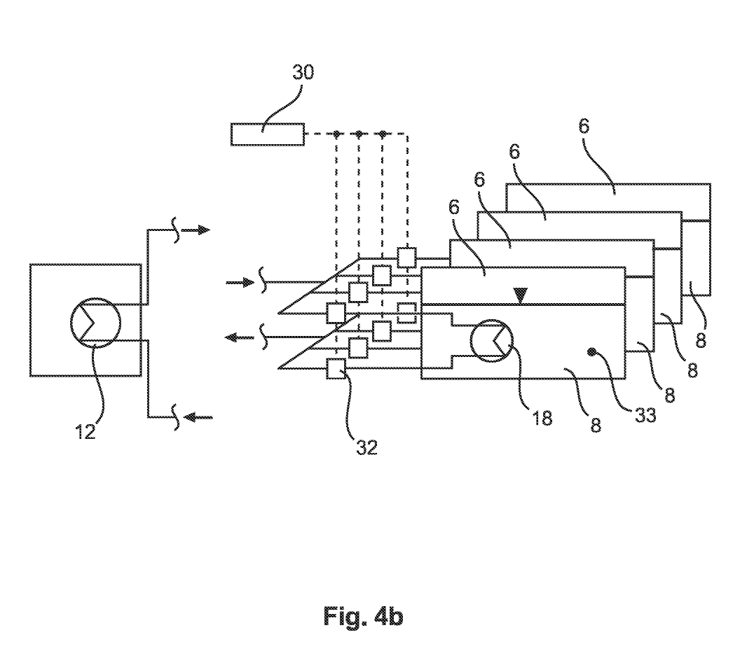

FIG. 4a shows that a control unit 30 can be connected to an arrangement comprising several valves 32, which arrangement controls the inflow and the outflow of fuel from several fuel tanks 6. For the sake of simplicity, only the first heat transfer device 12 and the fuel cell 2 are shown, because the arrangement comprising the control unit 30 and valves 32 can be applied to all embodiments. The control unit 30 is preferably designed to couple the fuel tanks individually one after the other (successively), in an alternating manner, or in groups to the first or the second cooling circuit. It is particularly advantageous to thermally connect the quantity of the fuel that has the lowest temperature with the fuel cell system. To this affect several temperature sensors 33 may be arranged in the individual fuel tanks 6 that are to be connected to the control unit. Respectively, de-coupled fuel tanks 6 can dissipate absorbed heat to the surroundings by way of the outside surfaces of the fuel tank 6. On the other hand, selective de-coupling of fuel tanks 6 also makes sense when from a group comprising several fuel tanks 6 one or several fuel tanks is/are completely empty and thus there is practically no longer a heat sink available.

As an alternative to the above, a slight modification in FIG. 4b can implement the same methodology as can the exemplary embodiment of FIG. 4a; however, in the embodiment of FIG. 4b second heat transfer devices 18 are accommodated in the individual fuel tanks 6, which heat transfer devices 18 are connected to the first heat transfer device 12 by way of valves 32.

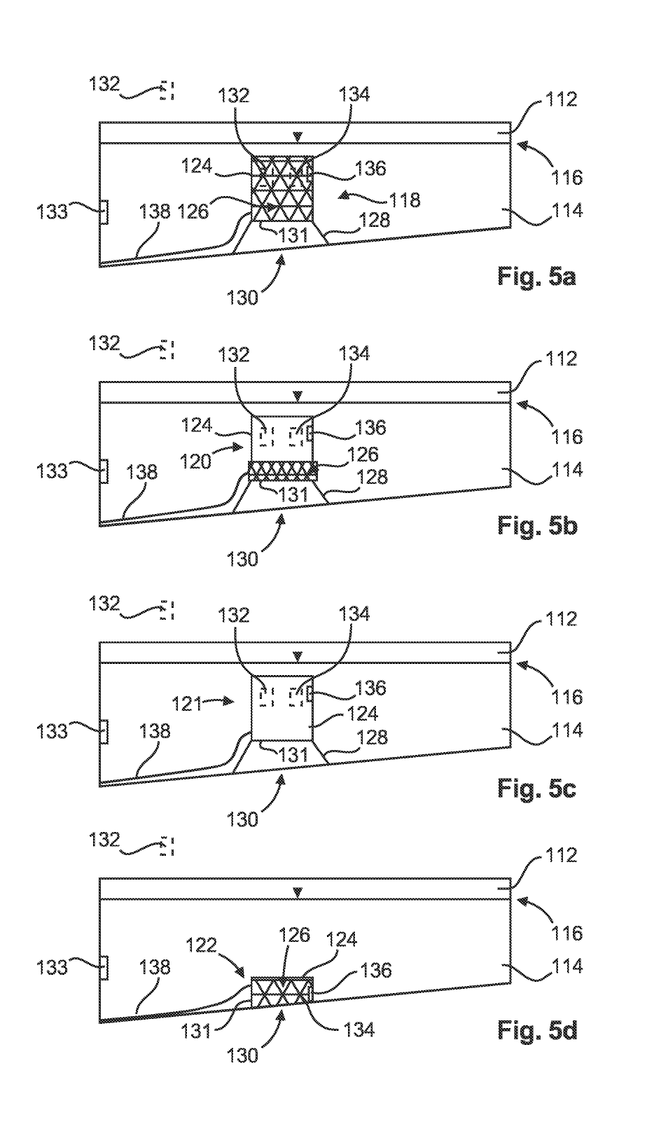

In FIG. 5a to FIG. 5d in each case a fuel tank 112 is shown that is filled with fuel 114 up to a level 116, wherein the fuel 114 in each case completely surrounds a fuel cell system 118, 120, 121 and 122 according to an embodiment. The depicted fuel cell systems 118, 120, 121 and 122 in each case differ by the presence and size or type of a heat dissipation device, by the position of said heat dissipation device in the fuel tank, and by the size of said heat dissipation device. While in FIG. 5a and FIG. 5d the fuel cell system 118 or 122 comprises a housing 124 that, for example, on all its walls accommodates a heat dissipation device 126 over its entire surface, FIG. 5b shows a housing 124 that comprises heat dissipation devices 126 only in some parts, whereas in FIG. 5c no special heat dissipation devices 126 are arranged on the housing 124.

The heat dissipation devices 126 that go beyond a mere housing character may, for example, comprise a suitable profile which significantly increases the outer surface of the heat dissipation device when compared to the housing 124, and, consequently, improved heat dissipation can take place. The size and position of these heat dissipation devices 126 depend on the expected heat load and the tolerated minimum fuel level, and consequently the embodiments are not limited to merely providing heat dissipation devices 126, or heat dissipation surfaces, that extend over the entire surface.

In each case a holding device 128 is arranged on the fuel cell systems 118, 120 and 121, which holding device 128 makes it possible to space the fuel cell system 118, 120 and 121 at a distance from the underside 130 and from all other walls of the fuel tank 112, and consequently the fuel cell system 118, 120 and 121 can be exposed to flowing fuel 114 on all sides. The fuel cell system 122 according to FIG. 5d is arranged directly on the underside 130 of the fuel tank, and correspondingly in this location does not comprise a heat dissipation device 126 or cooling-fin-like heat dissipation surfaces that allow fuel to flow through even if installed near the underside 130.

In the heat dissipation devices 126 one or several heat transfer surfaces have been implemented on which fuel 114 can absorb heat. As a result of convection caused by the aforesaid, and as a result of an associated convection flow within the fuel tank 112, rotational movement or transverse movement in the fuel tank 112 occurs, and consequently heated fuel 114 flows away from the fuel cell system 118, 120, 121 or 122, and cooler fuel 114 flows back against the heat transfer surfaces of the heat dissipation device 124.

The fuel cell system 118, 120, 121 or 122 can comprise an emergency shutdown device 132 that is able to stop operation of the fuel cell system 118, 120, 121 or 122 as soon as there is the likelihood of inadequate cooling occurring. This may be the case when the level 116 of the fuel 114 drops to below a predetermined minimum value, which depends on the specific design of the respective fuel cell system 118, 120, 121 or 122 or on the heat dissipation devices 126 arranged thereon.

As an alternative to this, switching-off may, for example, also occur when during monitoring of the temperature of the heat dissipation device 126 and/or of the housing 124 by means of a temperature sensor 131 it is detected that a defined maximum temperature of the heat dissipation device 126 is being exceeded. In this manner overheating of the fuel cell system 118, 120, 121 or 122 and subsequent impairment of the fuel tank 112 or ignition of the fuel 114 can be prevented.

As an alternative to the above the emergency shutdown device 132 can be arranged at a location outside the fuel tank so that the fuel cell system 118, 120, 121 or 122 can be shut down from the outside. This may, for example, be implemented in an already existing aircraft system or vehicle system, which system is designed to monitor the fuel level 116 of all the individual fuel tanks 112 with a level sensor 133.

The fuel cell systems 118, 120, 121 and 122 comprise, for example, a reformer 134, which can take fuel 114 directly from the fuel tank 112. To this effect the fuel cell system 118, 120, 121 or 122 may comprise a corresponding aperture 136 that has a nonreturn valve and/or other safety devices. Likewise, the fuel cell system 118, 120, 121 or 122 comprises, for example, at least one supply line 138 designed to remove reformate gas, exhaust gas and electricity from the fuel cell system 118, 120, 121 or 122. Likewise, by way of this supply line 138 it is also possible to implement shutdown or activation of operation of the fuel cell system 118, 120, 121 or 122, and fuel can be supplied if direct removal from the fuel tank 112 is not envisaged, or if an alternative fuel is to be used.

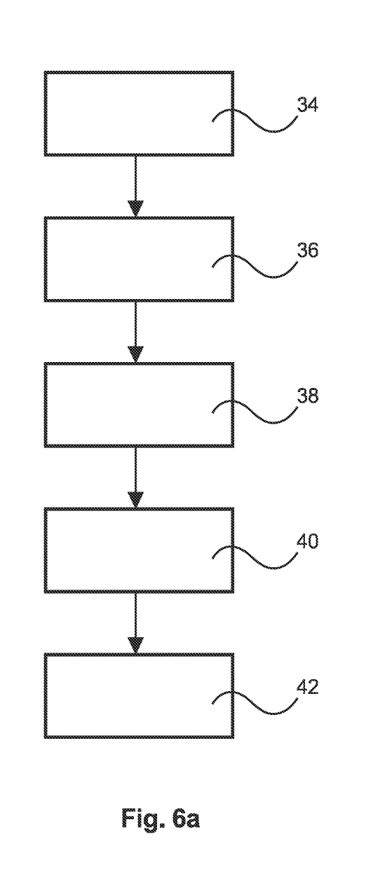

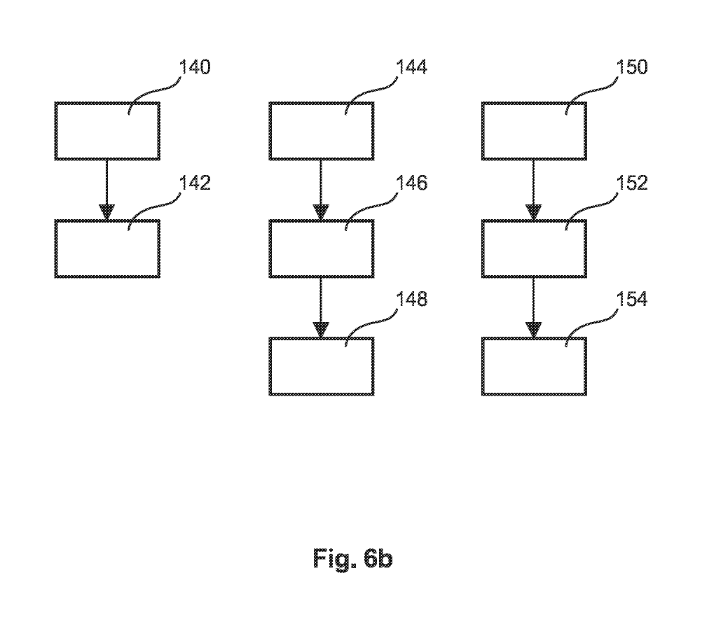

FIG. 6a diagrammatically shows a method according to an embodiment. Apart from conveying 34 a first cooling medium through a first heat transfer device 12 for absorbing heat from the fuel cell system 2, absorbed heat is transferred 36 to fuel in a fuel tank 6. This can be implemented by a second cooling circuit, in which the first fluid is conveyed 38 through flow channels of a second heat transfer device 18, flow-through occurs for dissipating heat. At the same time fuel is conveyed 40 through flow channels of the second heat transfer device 18 for dissipating heat. As has been shown in FIG. 4, the method optionally also includes thermal connection 42 to one or several fuel tanks, optionally at the same time, in an alternating manner or successively by means of a control unit.

FIG. 6b diagrammatically shows a further exemplary embodiment of the method. Apart from dissipating 140 heat from at least one fuel cell 4 to at least one heat dissipation device 126 and dissipating 142 heat to a fuel 114 that is in contact with the fuel cell system 118, 120, 121 and 122, optionally also the temperature of the heat dissipation device 126 and/or of the housing 124 is acquired 144, wherein the acquired temperature is compared 146 to a predetermined maximum temperature, and if the maximum temperature is exceeded, the fuel cell system 118, 120, 121 and 122 is shut down 148. As an alternative or in addition to the above it would also be possible for the fuel level 116 in the fuel tank 112 to be acquired 150 and to be compared 152 with a predetermined minimum fuel level. The fuel cell system 118, 120, 121 and 122 can be shut down 154 if the fuel level falls below the minimum fuel level.

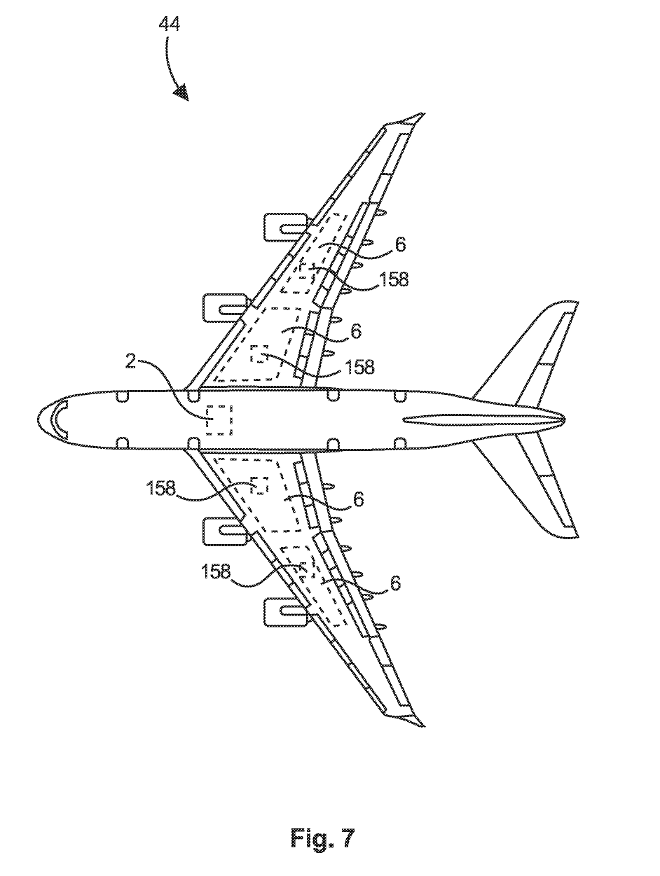

Finally, FIG. 7 shows an aircraft 44 comprising several fuel tanks 6 arranged as an example and not shown to scale, which aircraft 44 comprises at least one fuel cell system 2, and at least one cooling system for transferring the heat from the fuel cell system to one or several fuel tanks 6. If several fuel tanks 6 are used, in addition a control unit and a valve arrangement comprising several valves are imaginable, which arrangement provides for the use at the same time, in turns, or in an alternating manner, of one or several fuel tanks 6. In this manner it is possible, for example, to transfer heat in turns to various fuel tanks 6; as a result of a change to another fuel tank 6 the fuel tank 6 already impinged with heat can cool by heat dissipation to the environment, while another fuel tank 6 is at least for some time impinged with heat.

In addition or as an alternative, the aircraft may comprise several fuel cell systems 158 that are arranged in the fuel tanks 6 where they transfer heat, by way of their heat dissipation devices such as a housing or heat dissipation devices comprising specially formed heat dissipation surfaces, to the fuel 114. The fuel cell systems 158 can comprise any desired design, where FIG. 5a to FIG. 5d may, for example, provide some suggestions.

It should be pointed out that “comprising” does not exclude other elements or steps, and “a” or “an” does not exclude a plural number. Furthermore, it should be pointed out that characteristics or steps which have been described with reference to one of the above exemplary embodiments can also be used in combination with other characteristics or steps of other exemplary embodiments described above. While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A cooling system for cooling a fuel cell system in a vehicle, comprising:
at least one first heat transfer device that is configured to form a thermal connection between the fuel cell system and fuel from at least one fuel tank of the vehicle.

2. The cooling system of claim 1, further comprising:
a contact surface connecting the first heat transfer device to a heat-dissipating contact surface of the fuel cell system.

3. The cooling system of claim 1, wherein the first heat transfer device is configured for a flow of a first fluid from a first cooling circuit.

4. The cooling system of claim 3,
wherein the first heat transfer device is configured for connection to a fuel outlet for fuel to flow as the first fluid into the first heat transfer device, and
wherein the first heat transfer device is further configured to a fuel inlet for fuel to flow from the first heat transfer device to the fuel tank.

5. The cooling system of claim 3, further comprising:
at least one second cooling circuit with at least one second heat transfer device,
wherein the second heat transfer device is configured for arrangement in a fuel tank and further configured to transfer heat to the fuel surrounding the second heat transfer device.

6. The cooling system of claim 3, further comprising at least one second cooling circuit with at least one second heat transfer device with flow channels,
wherein the second heat transfer device is configured for connection to a fuel outlet for fuel to flow into the second heat transfer device,
wherein the second heat transfer device is further configured to a fuel inlet for fuel to flow out from the second heat transfer device into the fuel tank, and
wherein the first heat transfer device and the second heat transfer device are thermally interconnected.

7. The cooling system of claim 5, wherein the second heat transfer device is further configured for the first fluid to flow.

8. The cooling system of claim 7, wherein the first fluid comprises water.

9. The cooling system of claim 7, wherein the first fluid comprises oil.

10. The cooling system of claim 7, wherein the first fluid comprises ethanol.

11. The cooling system of claim 1, further comprising:
a valve arrangement comprising a plurality of valves; and
at least one control unit connected to the plurality of valves, the at least one control unit configured to connect the cooling system to the at least one fuel tank.

12. The cooling system of claim 11, further comprising a plurality of temperature sensors configured to acquire a temperature of the fuel in the fuel tanks,
wherein the plurality of temperature sensors are connected to the at least one control unit and the at least one control unit is further configured to connect the cooling system to the at least one fuel tank from several fuel tanks in which in the at least one fuel tank the temperature of the fuel is lower than that in remaining fuel tanks.

13. The cooling system of claim 1, further comprising a housing surrounding the fuel cell,
wherein the housing is substantially fuel-proof and configured to transfer heat from a operation of the fuel cell system to a fuel in a fuel tank, which fuel surrounds the housing.

14. The cooling system of claim 13, further comprising at least one heat dissipation device that is arranged on the housing.

15. The cooling system of claim 13, wherein the housing comprises a plurality of heat dissipation devices.

16. A fuel cell system comprising:
at least one fuel cell; and
at least one cooling system for cooling the at least one fuel cell, the at least one cooling system comprising at least one first heat transfer device that is configured to form a thermal connection between the fuel cell system and fuel from at least one fuel tank of the vehicle.

17. The fuel cell system of claim 16, further comprising an emergency shutdown device that is configured to shut off the fuel cell system as soon as adequate cooling can no longer be ensured.

18. An aircraft, comprising:
at least one fuel tank;
a fuel cell system comprising at least one fuel cell; and
at least one cooling system for cooling the at least one fuel cell, the at least one cooling system comprising at least one first heat transfer device that is configured to form a thermal connection between the fuel cell system and fuel from the at least one fuel tank of the aircraft.
